(19) United States
(12) Patent Application Publication
(10) Pub. No.: US 2005/0220440 A1
(43) Pub. Date: Oct. 6, 2005

(54) Method and apparatus for displaying number of video titles available at power on

(76) Inventor: Valerie Sacrez Liebhold, Carmel, IN (US)

Correspondence Address: Joseph S Tripoli;Thomson Licensing Inc, Two Independence Way, Princeton, NJ, 08540, US

(21) Appl. No.: 10/521,386

(22) PCT Filed: Jul. 18, 2003
(86) PCT No.: PCT/US03/22387

§ 371 Date: Jan. 18, 2005

Related U.S. Application Data
(60) Provisional application No. 60/396,931, filed on Jul. 18, 2002.

(51) Int. Cl. H04N 5/91

(52) U.S. Cl. 386/68

(57) ABSTRACT

An digital recording apparatus and a method for controlling a digital recording apparatus for allowing a user to quickly and easily determine a number of available programs stored on the recording apparatus. The present invention provides an initial on screen display in response to the receipt of a power ON command, placing the apparatus in a powered state, wherein the initial on screen display provides an indication of the number of available video programs stored on the apparatus. Alternatively, the initial on screen display may provide the number of video programs stored since the apparatus was last in the ON state, or the number of video programs stored since the user last accessed a full listing of stored programs.

This application claims priority to and all benefits accruing from a provisional application filed in the United States Patent and Trademark Office on Jul. 18, 2002, and there assigned Ser. No. 60/396,931.

### FIELD OF THE INVENTION

The present invention generally relates to a digital recording apparatus and a method for controlling a digital recording apparatus, and more particularly, to a digital recording apparatus and a method for controlling a digital recording apparatus that allows a user to easily determine the available number of video programs stored on the recording apparatus.

### RELATED ART

Personal video recorders (PVRs) are digital recording apparatuses that provide various features such as allowing a user to select for recording, by means of a graphical user interface (GUI) displayed on an associated television set, monitor, or other display device, a television program to be broadcast at a future time or which is currently being broadcast. Such apparatuses digitally record the selected program onto a storage module, such as a hard disk, and upon user command playback the stored program by retrieving it from storage, decompressing or decoding the program and outputting the video signal to an associated television set, monitor, or other display device. Apparatuses having such capabilities are currently sold under trade names such as “TiVo,” “RePlayTV,” “Sky+,” and “Showstopper.”

Such devices offer features and advantages in controlling the recording and playback of programs that were previously not available to the consumer via analog recording devices. The features include the ability to pause a live program on the screen while continuing to record the program onto a storage device such that the user can continue playback of the program at their convenience without missing any portion of the currently broadcast program, and also simultaneously recording and playing back, either the same program or different programs, thereby providing great flexibility in recording and playing back the received video signals. Since the programs are digitally stored and processed, the devices also allow the user to have greater control of the playback, for example, instantly skipping ahead by a predetermined amount of time. Such devices also generally are designed to work with a program guide that allows the user to easily see, in a grid format, program schedules, and to select a particular program for recording. The devices may also include input terminals for connecting playback devices, such as a camcorder, to the PVR to digitally record the contents of the devices onto the PVR for later playback.

Another convenient feature provided by PVRs is the ability to display a listing of programs that are stored on and available from the memory device associated with the PVR. Such a listing allows a user to, for example, easily determine what programs are available, and what new programs may have been recorded since the last time the PVR was used. However, current PVRs require the user to navigate a menu, or a series of menus, to display a listing of the available programs. Some PVRs include a display, such as an LED, that lights up to indicate that a new program has been recorded to the hard drive, but such a display does not give any information regarding the newly recorded program, the number of programs available from the hard disk, or how many new programs may have been recorded since the PVR was last used.

Further, current PVRs may provide an initial display, when placed in the power ON state from a standby state, which allows a user to select various options for controlling the PVR. From this initial display, the user must operate various keys on the remote control and navigate through the options in order to access a display that lists the available programs. This may be inconvenient for the user who wants to quickly determine how many, or what, new programs are available.

### SUMMARY OF THE INVENTION

In view of the above, it is desirable to provide an apparatus and a method that allows a user to easily and quickly determine the number of programs available on a digital recording device without having to navigate through a menu or a series of menus. The present invention provides a digital recording apparatus and a method for controlling a digital recording apparatus that addresses the inconvenience noted above by automatically providing an initial display, when the apparatus is placed in a power ON state, which displays the available number of programs associated with the apparatus.

In one embodiment, the invention provides a method for controlling a digital video recording apparatus, comprising the steps of: receiving a plurality of signals corresponding to a plurality of video programs from a signal source; selecting ones of the plurality of video programs for recording in response to user commands; storing the selected video programs in a storage device; maintaining data related to the video programs stored in the storage device; and providing, in response to the digital video recording apparatus being placed in a power ON state, an initial on screen display message indicating an available number of video programs stored in the storage device. The display may include selected attributes of the stored video programs, such as, the titles or times of recording. Alternatively, the available number of video programs may comprise only the number of video programs stored in the apparatus since the last time the apparatus was in the power ON state. Alternatively, the available number of programs may comprises only the number of video programs stored in the storage device since the last time the user accessed a full program listing display that lists all the programs stored on the apparatus.

In another embodiment, the invention provides a digital video recording apparatus, comprising: a signal input for receiving a plurality of signals corresponding to a plurality of video programs; tuning means for selecting ones of the plurality of video programs in response to user commands; recording means for storing the selected video programs in a storage device response to further user commands; generating means for generating on screen display messages; control means, coupled to and controlling the operation of the tuning means, the recording means and the generating means, the control means causing the generating means to generate, in response to the apparatus being placed in a power ON state, an initial on screen display message indicating an available number of video programs stored in the storage device. The display may include selected attributes of the stored video programs, including the titles or time of recording. Alternatively, the available number of video programs may comprise only the number of video programs stored in the apparatus since the last time the apparatus was in the power ON state. Alternatively, the available number of programs may comprises only the number of video programs stored in the storage device since the last time the user accessed a full program listing display that lists all the programs stored on the apparatus.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a digital recording apparatus suitable for implementing the present invention;

FIG. 2 is a flowchart illustrating exemplary steps for implementing a method according to the present invention; and

FIG. 3 is an exemplary screen message according to the present invention.

The exemplifications set out herein illustrate preferred embodiments of the invention, and such exemplifications are not to be construed as limiting the scope of the invention in any manner.

### DESCRIPTION OF THE PREFERRED EMBODIMENTS

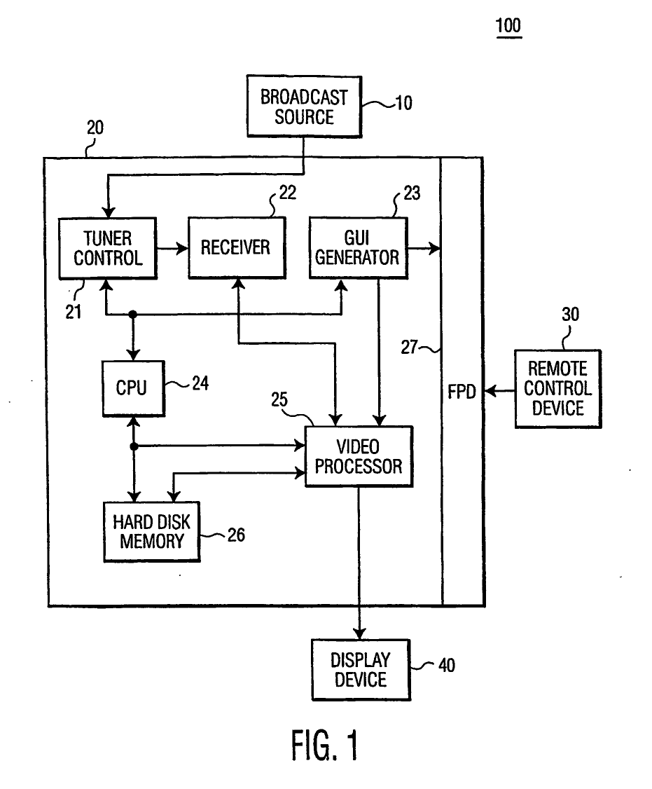

Referring now to the drawings, and more particularly to FIG. 1, an environment 100 suitable for implementing the present invention is shown. As shown in FIG. 1, environment 100 comprises a digital recording device 20, which includes various elements for receiving and processing program signals and generating audio and video signals suitable for display. Digital recording device 20 is coupled to a broadcast source 10 for receiving program signals, a remote control device 30 for receiving user input signals, and a display device 40 for providing a program display. Display device 40 may be included with the elements of digital recording device 20 as an integrated package. Also shown in FIG. 1, digital recording apparatus 20 comprises a tuner control block 21, a receiver 22, a GUI generator 23, a controller 24, a video processor 25, and a hard disk memory 26. As will be intuitive to those skilled in the art, many of the foregoing elements, or combination of elements, of apparatus 20 may be embodied using integrated circuits (ICs). The construction and operation of the elements of apparatus 20 are generally known to those skilled in the art and will be discussed as necessary to provide an understanding of the invention.

In FIG. 1, broadcast source 10 is operative to provide data including video signals to digital recording apparatus 20 for recording. Broadcast source 10 may, for example, provide data to apparatus 20 via a terrestrial, satellite, cable, Internet, or other type of wired or wireless communication link. An electronic program guide (EPG) may be provided along with video programs via broadcast source 10 or through a separate link, for example, a telephone link, to allow the user to use a “one touch” method of programming apparatus 20 to record certain desired video programs. The information provided by the EPG may also be stored with the recorded programs to provide additional information about the recorded programs. Broadcast source 10 may also represent a live or recorded signal provided through a device connected to digital recording apparatus 20 such as one provided from a camcorder, DVD player or other similar device.

Digital recording apparatus 20 is operative to digitally record data provided from broadcast source 10, and may be embodied as a PVR or other digital video recording device, such as a digital versatile disk (DVD) recording device. Apparatus 20 may also be embodied as a combination player that includes a hard disk recording device that includes a disk player (not shown). According to an exemplary embodiment, tuner control block 21 is operative to receive data from broadcast source 10 and perform a tuning function to generate tuned signals. Receiver 22 is operative to receive and process the tuned signals provided from tuner control block 21 to thereby generate corresponding IF and baseband signals. GUI generator 23 is operative to generate GUI displays (e.g., bitmap images) corresponding to different operating modes of apparatus 20. GUI displays are generated and displayed on display device 40 to, for example, provide status information regarding the operation of apparatus 20, or menus for allowing the user to make various selections to control the operation of apparatus 20. As will be discussed later herein, a user may provide inputs to apparatus 20 responsive to such GUI displays to control the operation of apparatus 20.

Controller 24 is operative to perform the overall control of the various components of apparatus 20. According to an exemplary embodiment, controller 24 generates various control signals, which control the operation of the other elements of apparatus 20 to provide the known digital recording features, such as pausing a portion of the received video on the display device 40 while continuing to record the incoming video on hard drive memory 26 for future playback. Video processor 25 is operative to perform various video processing functions of apparatus 20, such as decompressing, decoding, encoding, etc, to generate video signals suitable for display on device 40. According to an exemplary embodiment, video processor 25 processes and formats video signals provided from receiver 22, as well as video data retrieved from hard disk memory 26 to enable corresponding visual displays on display device 40, for example in the NTSC or PAL format. Video processor 25 may also combine such video images with GUI displays generated by GUI generator 23. The combination may be implemented with a switching device (not shown) that switches between the video signal and the GUI signal to overlay the GUI display onto the program display.

Hard disk memory 26 is operative to store digital video data under the control of controller 24. The video program data may be provided by video processor 25, and stored on hard disk memory 26, in a compressed format, for example, MPEG-2, JVT, etc., to maximize the storage of the video data in memory 26. A table or listing of programs stored on the hard disk may be stored on the hard disk under the control of controller 24. The programs and the listing of programs may be stored on the hard disk using conventionally known methods, including using contiguous or non-contiguous blocks of data that are identified using a file allocation table. The listing may also be stored on a memory device separate from the hard disk. Although memory 26 is shown in FIG. 1 as a hard disk memory for purposes of example, it may also be embodied in another form that is capable of storing large amounts of digital video data, such as one or more optical disks, flash memory, removable hard disk, solid state memory or the like.

Remote control device 30 is operative to provide user control inputs to digital recording apparatus 20, and may for example be embodied as a hand-held remote control, keyboard, or other input device such as an input terminal integral with apparatus 20. Remote control device 30 may be coupled to a receiver (not shown) contained in recording apparatus 20 via a wired or wireless medium, for example RF or IR signaling. According to an exemplary embodiment, a user may use remote control device 30 to transmit commands to control the various operating modes of apparatus 20, such as to select a television program to be recorded from an EPG displayed on display device 40, and to respond to a screen message displayed on display device 40. Although not expressly indicated in FIG. 1, controller 24 is operative to receive and process user inputs provided to apparatus 20 via remote control device 30. Display device 40 is operative to visually display images responsive to the video output signals provided from video processor 25, and may for example be embodied as a television screen, monitor, or other display device.

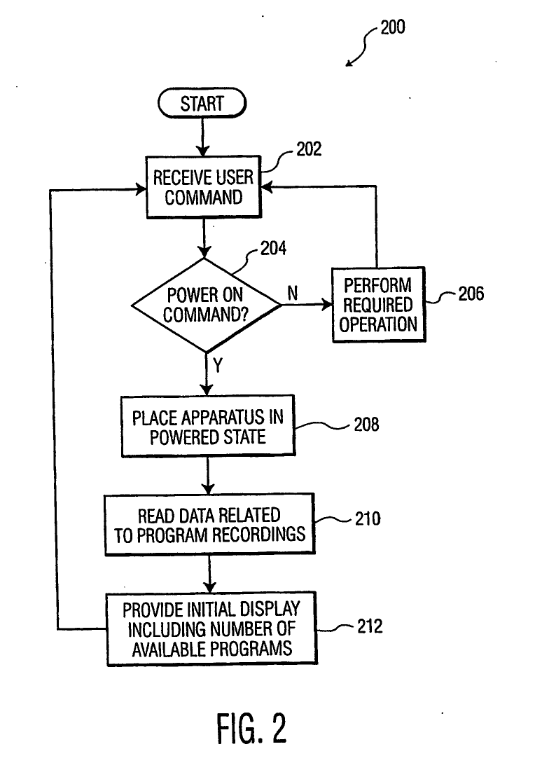

Referring now to FIG. 2, a flowchart 200 illustrating exemplary steps according to an embodiment of the present invention is shown. For purposes of example and explanation, the steps of FIG. 2 will be described with reference to digital recording apparatus 20 of FIG. 1. The steps of FIG. 2 are merely exemplary, and are not intended to limit the present invention in any manner.

At step 202, apparatus 20 receives a user input command for controlling the operation of apparatus 20. The command may be, for example, to perform a RECORD operation, wherein apparatus 20 is programmed to tune to a particular channel during a desired time period and record a selected video program onto the hard disk memory 26. This operation may be generated in response to an input responsive to an EPG displayed on display device 40, e.g., through a one-touch record method. Alternatively, the RECORD operation may be generated in response to user actuation of the “RECORD” key on remote control device 30, which results in a record command without specifying a total recording time. As a result of the RECORD operations, a plurality of video programs, and data related to the video programs, are stored on hard disk memory 26.

At step 204, it is determined whether the received user command is a power ON command. If not, apparatus 20 goes to step 206 and performs the necessary operations according to the received user command. If the received user command is a power ON command, apparatus 20 is placed in a power ON state in step 208. Placing apparatus 20 in a power ON state may comprise, for example, providing operating power to the elements shown in FIG. 1.

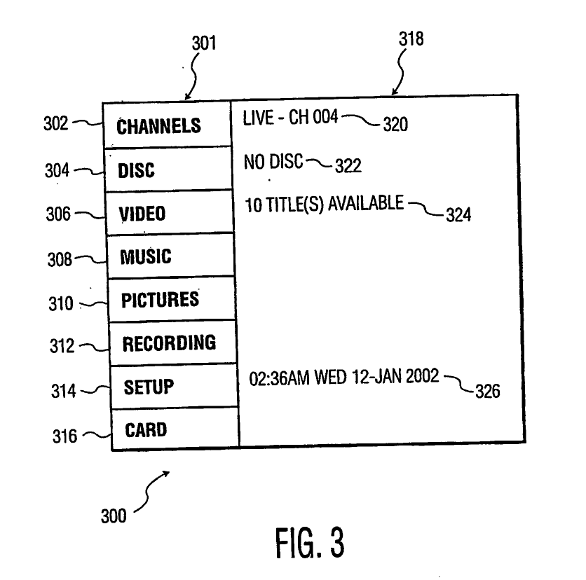

At step 210, the data related to the video programs stored in memory 26 is read out. The data may include, for example, the total number of video programs stored in memory 26, the number of video programs stored in memory 26 since apparatus 20 was last placed in the power ON state, the number of video programs stored in memory 26 since the last time a full listing of all video programs stored in memory 26 was accessed by the user, and attributes associated with the stored programs, such as, but not limited to, titles, time of recording, recording duration, etc. This data is used to generate an initial on screen display that is provided to the user in response to the power ON command at step 212. In this manner, the invention provides to the user an initial OSD on display device 40 that allows the user to easily determine information regarding the stored video programs without requiring further user navigation of the menus. An example of the screen message provided at step 212 is shown in FIG. 3.

As shown in FIG. 3, exemplary screen message 300 includes various parameters for allowing a user to easily determine the state of apparatus 20 and the recordings available from apparatus 20. Message 300 includes left side display portion 301 that lists various buttons representative of various categories of information.

The various categories buttons may be selected by the user to obtain further information within that category. Channels button 302 may be selected to obtain additional information regarding the programming scheduled on the various available channels. Disc button 304 may be selected to obtain additional information regarding video or audio discs that are included in a disc player associated with apparatus 20. Video button 306 may be selected to obtain additional information regarding video programs stored on hard disk memory 26. The additional information may include, for example, the title, program category, channel, duration, actors, a summary, etc. Music button 308 may be selected to obtain a listing and additional information regarding audio program files stored on hard disk memory 26 in, for example, the MP3 format. Pictures button 310 may be selected to obtain a listing and additional information regarding picture files stored on hard disk memory 26. Recording button 312 may be selected to obtain a listing and additional information regarding programs that are scheduled to be recorded. Setup button 314 may be selected to access setup menus for controlling various setup parameters of apparatus 20. Card button 316 may be selected to view material stored on a memory card attached to apparatus 20. The memory card may be attached via a card reader that is connected to or integral to apparatus 20.

The right side display portion 318 includes data associated with the category buttons on left side display portion 301. Display portion 320 indicates that apparatus is providing an output that corresponds to a live display of the program on channel 004. Display portion 322 indicates that there are no discs inserted in the disc player associated with apparatus 20. Display portion 324 indicates that 10 titles are stored and available for display from apparatus 20. Although no indications are displayed with regard to buttons 308-310, it is to be understood that displays that indicate the total number of music files and picture files stored on hard disk memory 26 may also be shown as desired. Display portion 326 indicates the current time and date.

Although in the exemplary message, the total number of titles available are displayed, it is to be understood that other variations are contemplated. In an alternative embodiment, display portion 324 can be arranged to display the total number of video programs that have been recorded on hard disk memory 26 since the last time apparatus 20 was placed in the power ON state. In another embodiment, display portion 324 can be arranged to display the total number of video programs that have been recorded on hard disk memory 26 since the last time a full program listing display, listing all of the programs available on hard disk memory 26, was accessed by the user. In another embodiment, various attributes associated with the programs stored on hard disk memory 26 may be display on message 300, for example, titles of the programs, time of recording, etc. The type of numbers or attributes to be displayed may be selected through a set up menu. It is clear that using message 300 the user is able to immediately and easily determine the number of available programs, and/or attributes of the programs, when the apparatus is placed in a power ON state.

It is to be understood that the present invention may be implemented in various forms of hardware, software, firmware, special purpose processors, or a combination thereof. Preferably, the present invention is implemented as a combination of hardware and software. Moreover, the software is preferably implemented as an application program tangibly embodied on a program storage device. The application program may be uploaded to, and executed by, a machine comprising any suitable architecture. Preferably, the machine is implemented on a platform having an operating system and microinstruction code. The various processes and functions described herein may either be part of the microinstruction code or part of the application program (or a combination thereof), which is executed via the operating system.

It is to be further understood that, because some of the constituent system components and method steps depicted in the accompanying Figures are preferably implemented in software, the actual connections between the system components (or the process steps) may differ depending upon the manner in which the present invention is programmed. Given the teachings herein, one of ordinary skill in the related art will be able to contemplate these and similar implementations or configurations of the present invention.

While this invention has been described as having a preferred design, the present invention can be further modified within the spirit and scope of this disclosure. This application is therefore intended to cover any variations, uses, or adaptations of the invention using its general principles. For example, it is clear that the principles of this invention is applicable to recording devices that utilize different recording media, or combination of media, such as CD and DVD discs. Thus, this invention may be utilized to provide information regarding programs stored on each of the different recording media, or combination of media. Also, it is clear that the principles of this invention is applicable to devices wherein the memory device is disposed outside, or is externally connected to, the digital signal processing apparatus, for example, an environment wherein the signal processing functions are disposed within a digital set top box (DSTB) and the memory device is external to the DSTB, or is an allocated portion of a central server that is located at a service provider facility. Further, this application is intended to cover such departures from the present disclosure as come within known or customary practice in the art to which this invention pertains and which fall within the limits of the appended claims.

1. A method for controlling a digital video recording apparatus, comprising the steps of:
receiving a plurality of signals corresponding to a plurality of video programs from a signal source;
selecting ones of the plurality of video programs for recording in response to user commands;
storing the selected video programs in a storage device;
maintaining data related to the video programs stored in the storage device; and
providing, in response to the digital video recording apparatus being placed in a power ON state, an initial on screen display message indicating an available number of video programs stored in the storage device.

2. The method according to claim 1, wherein the available number of video programs comprises a number of video programs stored in the storage device since the last time the apparatus was in the power ON state.

3. The method according to claim 2, wherein the initial on screen display message further displays selected attributes of the available number of video programs stored in the storage device.

4. The method according to claim 3, wherein the selected attributes includes the titles of the available number of video programs.

5. The method according to claim 3, wherein the selected attributes includes the time the respective ones of the available number of video programs was stored in the storage device.

6. The method according to claim 1, wherein the available number of programs comprises a number of video programs stored in the storage device since a last time the user accessed a full program listing display that lists all the programs stored on the storage device.

7. The method according to claim 6, wherein the initial on screen display message further displays selected attributes of the available number of video programs stored in the storage device.

8. The method according to claim 7, wherein the selected attributes includes the titles of the available number of video programs.

9. The method according to claim 7, wherein the selected attributes includes the time the respective ones of the available number of video programs was stored in the storage device.

10. A digital video recording apparatus, comprising:
a signal input for receiving a plurality of signals corresponding to a plurality of video programs from a signal source;
tuning means for selecting ones of the plurality of video programs in response to user commands;
recording means for storing the selected video programs in a storage device response to further user commands;
generating means for generating on screen display messages;
control means, coupled to and controlling the operation of the tuning means, the recording means and the generating means, the control means causing the generating means to generate, in response to the apparatus being placed in a power ON state, an initial on screen display message indicating an available number of video programs stored in the storage device.

11. The method according to claim 10, wherein the available number of video programs comprises a number of video programs stored in the storage device since the last time the apparatus was in the power ON state.

12. The method according to claim 11, wherein the initial on screen display message further displays selected attributes of the available number of video programs stored in the storage device.

13. The method according to claim 12, wherein the selected attributes includes the titles of the available number of video programs.

14. The method according to claim 12, wherein the selected attributes includes the time the respective ones of the available number of video programs was stored in the storage device.

15. The method according to claim 10, wherein the available number of programs comprises a number of video programs stored in the storage device since a last time the user accessed a full program listing display that lists all the programs stored on the storage device.

16. The method according to claim 15, wherein the initial on screen display message further displays selected attributes of the available number of video programs stored in the storage device.

17. The method according to claim 16, wherein the selected attributes includes the titles of the available number of video programs.

18. The method according to claim 16, wherein the selected attributes includes the time the respective ones of the available number of video programs was stored in the storage device.
